(19) United States
(12) Patent Application Publication
(10) Pub. No.: US 2009/0234888 A1
(43) Pub. Date: Sep. 17, 2009

(54) Method and system for producing a mood guided media playlist

(75) Inventors: Sunny Holmes, Redondo Beach, CA (US); Chris Heatherly, Monrovia, CA (US); Randal Ouye, La Crescenta, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., BURBANK, CA (US)

(21) Appl. No.: 12/229,410

(22) Filed: Aug. 22, 2008

Related U.S. Application Data
(60) Provisional application No. 61/069,760, filed on Mar. 17, 2008.

(51) Int. Cl. G06F 17/30

(52) U.S. Cl. 707/104.1; 707/E17.002

(57) ABSTRACT

There is provided a method of providing a mood guided media playlist. The method comprises identifying a mood rating of media assets stored in a media assets database; labeling the media assets with metatags corresponding to the mood rating; identifying a mood theme according to an input received from a client computer; designating mood associated media assets corresponding to the mood theme from the labeled media assets; determining a media playlist length corresponding to the mood theme; assembling a media playlist having the media playlist length corresponding to the mood theme, from the mood associated media assets; and providing the media playlist for displaying. The method may comprise providing a mood selection virtual tool enabling a user of the client computer to recognize and select a desired mood theme, wherein the mood selection virtual tool can display a spectrum of colors corresponding to a plurality of user selectable mood themes.

### RELATED APPLICATIONS

This application claims priority to U.S. Provisional Application No. 61/069,760, filed on Mar. 17, 2008, which is hereby incorporated by reference in its entirety.

### BACKGROUND OF THE INVENTION

1. Field of the Invention

The present invention relates generally to the management of media content. More particularly, the present invention relates to computer mediated selection of media content.

2. Background Art

Advances in modern communications and information storage technology have turned the traditional challenges to enjoying desirable media content, such as music, videos, or movies, for example, on their head. Where not so long ago, the challenges were typically those of scarcity or inconvenience in accessing desirable content, today the challenges arise from the abundance of potentially desirable content and the ease with which much of it may be obtained. For example, traditional obstacles to enjoying desirable content, such as the need to locate and gain possession of an item of physical media on which the content is recorded, are much less often a hindrance today, when so much content may be so easily downloaded to a personal computer or personal communication device over the Internet or other network.

Perhaps counterintuitively, the present ease with which such a variety of media content may be accessed and obtained has produced disadvantages of its own, arising from difficulties in quickly identifying and gathering media content that may be temporarily highly desirable. Temporary circumstances such as environmental conditions, the type of activity in which one is engaged, or simple fluctuations in mood, may significantly change an individual's present preferences for media consumption. Considering individual tastes in music, for example, particular musical selections present in a personal music library comprising entries that are collectively thought to be desirable in general, may be more or less especially desirable depending on the context in which they are to be played back. For instance, the “in the moment” desirability of an up-tempo pop song may vary considerably depending on whether it is to be used as an accompaniment to a vigorous exercise session, or to create a romantic ambience for an intimate meal.

Extracting media content that is highly desirable in the moment, from the vastly greater body of commonly stored media content that is less so, can be a demanding, time consuming, and even frustrating undertaking. The active efforts required in order to differentiate among alternative items of content to distinguish those items having a temporarily high desirability, may undermine the pleasure otherwise obtainable from a more seamless and immediate access to those items. Consequently, the wealth of desirable media content available to a user may be rendered far less enjoyable than it might be, due to its being subsumed and made unrecognizable by its own abundance.

Continuing with the example of music content, such as personal music content stored on a digital media player, one conventional solution to the problem of quickly identifying desirable content from a large library requires the user to create media playlists. This approach allows the user of the music player to anticipate situations in which certain musical selections may be more desirable, and to collect those desirable selections and associate them with a theme. A significant disadvantage of this widely implemented conventional solution, however, is that it requires the user to foresee future preferences, which may arise quite spontaneously, and to pre-select music in accord with those anticipated desires. In addition, this conventional approach requires the user to actively sort through existing media content to manually create the playlists, and to manually update those lists as new media content is added to the library from which the playlists are drawn.

In addition, this approach requires some degree of expertise in the use of the media content management resources available on a typical media player. Consequently, novice users may fail to enjoy the full functionality provided by those devices due to their unfamiliarity with the use of media playlists. Moreover, novice users, while perhaps appreciating the enhanced entertainment value provided by customizing a playback sequence, may be averse to acquiring the skills necessary to produce the media playlists delivering that added value. Children, in particular, may enjoy the results of playlist operation, but struggle to understand the organizing concepts required for their genesis.

As an alternative conventional solution, users may elect to avoid the burdens of producing their own media playlists by ceding control of playlist creation to the media player itself. Use of a conventional digital media player in “shuffle” mode, for example, results in playback of individual items of stored content in a random sequence. While perhaps effective in reducing the personal stresses created by having to actively contend with playlist production, this conventional approach deprives the user of the potential benefits available from a selective harvesting of available content based on its in the moment desirability.

Accordingly, there is a need to overcome the drawbacks and deficiencies in the art by providing a user friendly content management solution enabling selection of media content in a less analytical and more intuitive way, thereby providing ready access to media content having enhanced desirability.

### SUMMARY OF THE INVENTION

There are provided methods and systems for producing a mood guided media playlist, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of a system for producing a mood guided media playlist, according to one embodiment of the present invention;

FIG. 2 shows a more detailed exemplary embodiment of a system for producing a mood guided media playlist, according to one embodiment of the present invention;

FIG. 3 is a flowchart presenting a method for producing a mood guided media playlist, according to one embodiment of the present invention;

FIG. 4 shows a visual frame of an exemplary display enabling a user to produce a mood guided playlist, according to one embodiment of the present invention; and

FIG. 5 shows a visual frame of a display enabling a user to produce a mood guided media playlist having a different mood theme than that shown in FIG. 4, according to an embodiment of the present invention.

### DETAILED DESCRIPTION OF THE INVENTION

The present application is directed to methods and systems for producing a mood guided media playlist. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals.

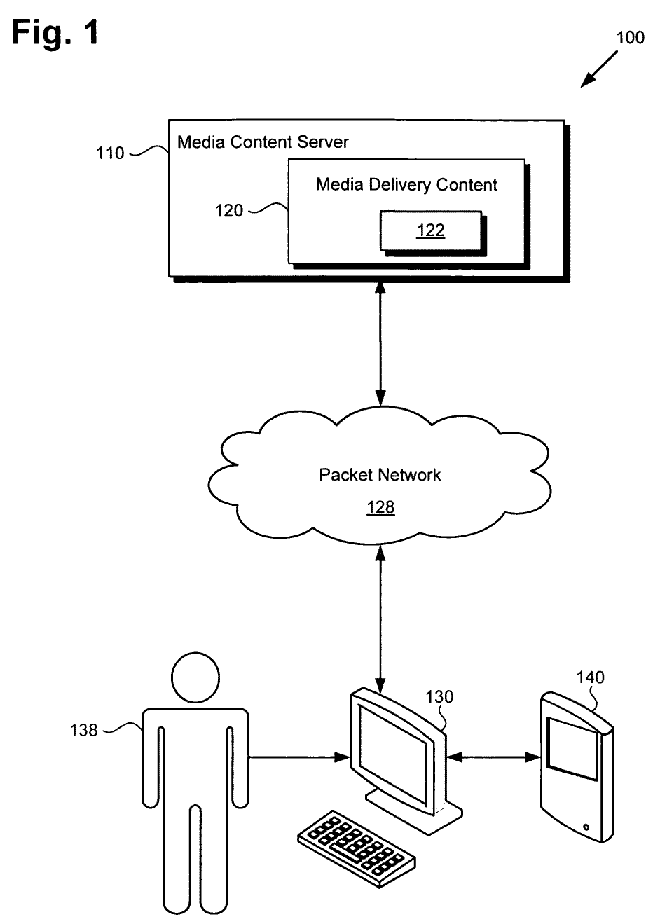

FIG. 1 shows a diagram of exemplary system 100 for producing a mood guided media playlist, according to one embodiment of the present invention. In the embodiment of FIG. 1, system 100 comprises media content server 110, media delivery content 120 including interactive mood guided playlist assembly application 122, packet network 128, client computer 130, and digital media player 140. Also shown in FIG. 1 is user 138.

According to the embodiment of FIG. 1, user 138 may utilize client computer 130 and packet network 128 to access media delivery content 120 stored on media content server 110. User 138 may then use interactive mood guided playlist assembly application 122 to acquire media assets and assemble one or more mood guided media playlists. User 138 may subsequently transfer the one or more mood guided media playlists to digital media player 140, for enjoyment at another time. Although in the embodiment of FIG. 1, client computer 130 is represented as a personal computer (PC), in one embodiment client computer 130 may be a mobile communication device such as a mobile telephone, personal digital assistant (PDA), wireless computer, or wireless gaming console, for example. Moreover, although according to the present embodiment, client computer 130 and digital media player 140 are separate devices, in one embodiment, they may be integrated into a single mobile communication device.

As shown in FIG. 1, media delivery content 120 may be accessed through packet network 128. In that instance, interactive mood guided playlist assembly application 122 may comprise a web application, accessible over a packet network such as the Internet, for example. Alternatively, interactive mood guided playlist assembly application 122 may reside on a server supporting a local area network (LAN), in the theme park context, for instance, or included in another type of limited distribution network.

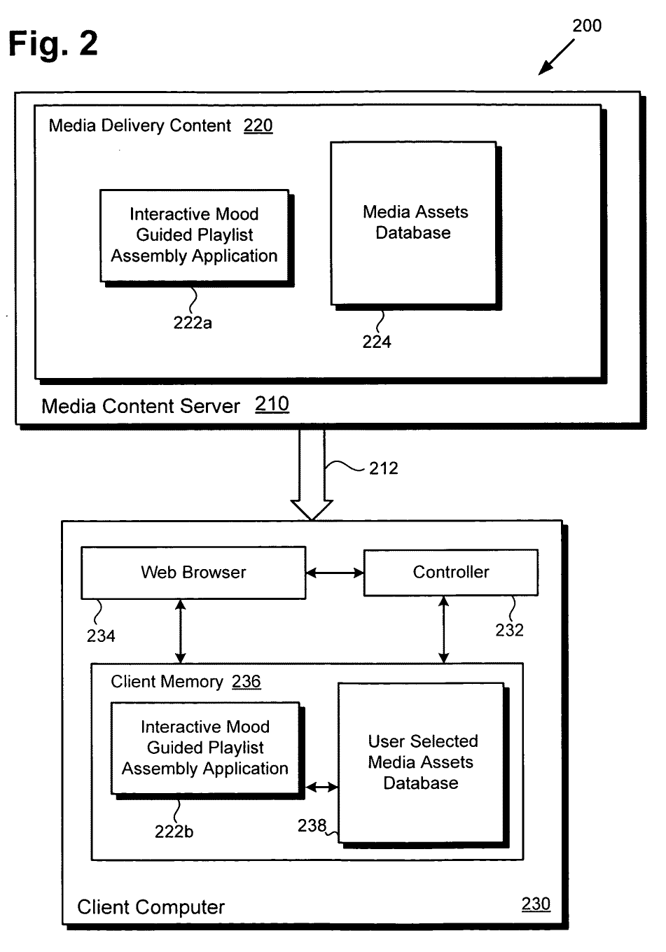

FIG. 2 provides a more detailed embodiment showing system 200 for producing a mood guided media playlist, according to one embodiment of the present invention. System 200 in FIG. 2 includes client computer 230 receiving download 212 from media content server 210 including media delivery content 220. Client computer 230 corresponds to client computer 130, in FIG. 1. As shown in FIG. 2, client computer 230 comprises controller 232, web browser 234, and client memory 236.

Media content server 210, and media delivery content 220 correspond respectively to media content server 110 and media delivery content 120, in FIG. 1. As shown in FIG. 2, media delivery content 220 comprises interactive mood guided playlist assembly application 222a, which corresponds to interactive mood guided playlist assembly application 122, in FIG. 1, as well as media assets database 224 configured to store a plurality of media content. Also shown in FIG. 2 are interactive mood guided playlist assembly application 222b and user selected media assets database 238.

In one embodiment, user selected media assets database 238 may comprise media assets imported from media assets database 224, through purchase and download from media content server 210, for example. In another embodiment, user selected media assets database 238 may comprise media assets imported from a portable computer-readable storage medium, through upload from a compact disc (CD), or optical disc, for example. In any event, user selected media assets database 238 is configured to comprise media content corresponding to the plurality of media content stored in media assets database 224, by virtue of having a data format and/or metadata compatible with the plurality of media content residing in media assets database 224. Although in the embodiment of FIG. 2, user selected media assets database is shown to reside on client computer 230, in an embodiment in which interactive mood guided playlist assembly application 222a is executed by client computer as a web application, user selected media assets database 238 may reside server-side, and be included in media delivery content 220, for example.

In the present embodiment, interactive mood guided playlist assembly application 222b is located in client memory 236, having been received from media content server 210 via download 212. In one embodiment, download 212 corresponds to transfer of interactive mood guided playlist assembly application 222a over a packet network, for example. In another embodiment, the download may correspond to transfer of interactive mood guided playlist assembly application 222a from a compact disc read-only memory (CD-ROM) or other computer-readable medium. Once downloaded, interactive mood guided playlist assembly application 222b may be stored in client memory 236 and run locally on client computer 230, as a desktop application, for example.

The expression “computer-readable medium,” as used in the present application, refers to any medium that provides instructions to controller 232 of client computer 230. Thus, a computer-readable medium may correspond to various types of media, such as volatile media, non-volatile media, and transmission media, for example. Volatile media may include dynamic memory, such as dynamic RAM, while non-volatile memory may include optical, magnetic, or electrostatic storage devices. Transmission media may include coaxial cable, copper wire, or fiber optics, for example, or may take the form of acoustic or electromagnetic waves, such as those generated through radio frequency (RF) and infrared (IR) communications. Common forms of computer-readable media include, for example, a CD-ROM, digital video disc (DVD), or other optical disc; a RAM, programmable read-only memory (PROM), erasable PROM (EPROM), FLASH memory, or a transmission carrier wave.

Controller 232 may be the central processing unit for client computer 230, for example, in which role controller 232 runs the client computer operating system, launches web browser 234, and facilitates execution of interactive mood guided playlist assembly application 222b. Web browser 234, under the control of controller 232, may execute interactive mood guided playlist assembly application 222b to enable a user of client computer 230 to produce a mood guided media playlist utilizing media assets from user selected media assets database 238. Although in one embodiment, interactive mood guided playlist assembly application 222b may draw media assets exclusively from user selected media assets database 238, in other embodiments media assets may be imported from media content sources other than or in addition to user selected media assets database 238, such as other locations in client memory 236 or an external memory device, for example.

Implementation of the embodiment of FIG. 2 permits a user of client computer 230 to run interactive mood guided playlist assembly application 222b to produce a mood guided media playlist. In another embodiment, a user of client computer 230 may access interactive mood guided playlist assembly application 222a running on media content server 210, to produce one or more mood guided media playlists from media assets stored on media asset database 224. In that latter embodiment, interactive mood guided playlist assembly application 222a may be utilized by a user of client computer 230 as a selection tool for acquisition of media assets, for example, either through purchase and download from media assets database 224, or from another source. It is noted that for the purposes of the present application, the term media assets has broad application, and may correspond to music content, music video content, video content, television content, and movie content, for example.

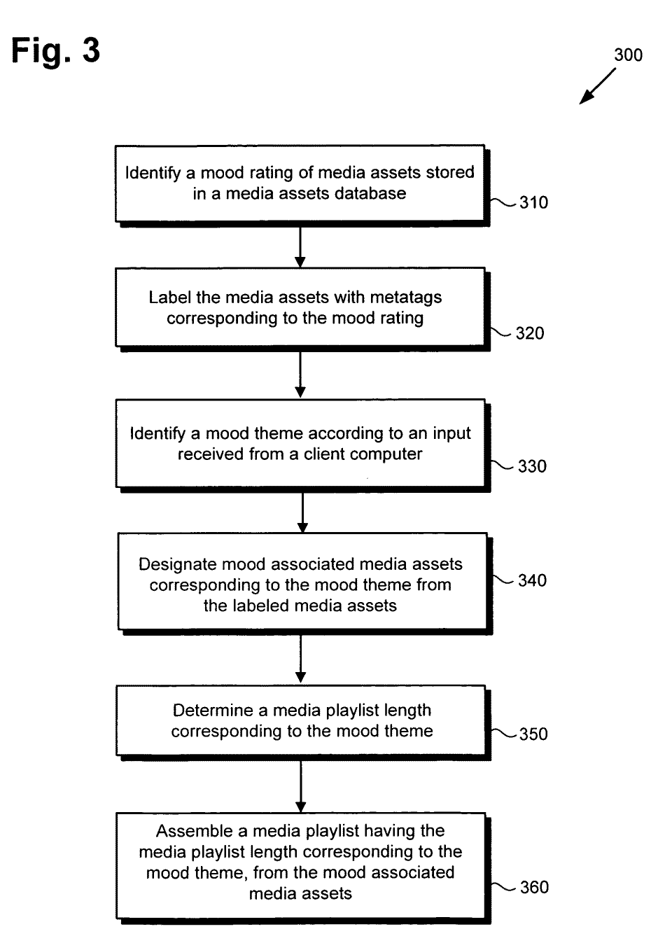

FIGS. 1 and 2 are now further described in conjunction with flowchart 300, shown in FIG. 3, which presents a method for producing a mood guided media playlist, according to one embodiment of the present invention. Certain details and features have been left out of flowchart 300 that are apparent to a person of ordinary skill in the art. For example, a step may consist of one or more substeps or may involve specialized equipment or materials, as known in the art. While steps 310 through 360 indicated in flowchart 300 are sufficient to describe one embodiment of the present method, other embodiments may utilize steps different from those shown in flowchart 300, or may include more, or fewer steps.

Beginning with step 310 in FIG. 3 and system 200 in FIG. 2, step 310 of flowchart 300 comprises identifying a mood rating of media assets stored in a media assets database. In the embodiment of FIG. 2, step 310 may correspond to access by interactive mood guided playlist assembly application 222b of media assets stored locally in user selected media assets database 238, in order to identify mood related characteristics of the stored assets. For example, interactive mood guided playlist assembly application 222b may be used to parse items of media content stored as media assets in user selected media assets database 238, to determine a media genre, or, in the case of music or other audio assets, a metric such as beats per minute, to determine a mood rating for each media asset.

Flowchart 300 continues with step 320, comprising labeling the media assets stored in user selected media assets database 238 with metatags corresponding to the mood rating determined in step 320. In the embodiment of FIG. 2, step 320 may be performed by interactive mood guided playlist assembly application 222b, running on client computer 230.

Turning to step 330 of flowchart 300, step 330 comprises identifying a mood theme according to one or more inputs received from client computer 230. For example, interactive mood guided playlist assembly application 222b might prompt a user of client computer 230 to enter a word corresponding to a recognized mood theme, such as “excited” or “relaxed” into a mood field. In another embodiment the user may be prompted by interactive mood guided playlist assembly application 222b to choose a mood theme by highlighting a selection displayed on a pull-down mood menu.

In one embodiment, the method of flowchart 300 may further comprise a step (not shown in FIG. 3) of providing a mood selection virtual tool enabling a user of interactive mood guided playlist assembly application 222b to intuitively recognize and select a desired mood theme. For example, a mood selection virtual tool provided by interactive mood guided playlist assembly application 222b may include a mood selection button which can be moved along a mood range from a very relaxed to a highly stimulated mood state. In one embodiment, the mood range may comprise a mood continuum given visual representation by a spectrum of colors paralleling the mood range and providing visual cues to corresponding moods. For instance, the region adjacent to a very relaxed mood may be colored deep blue, while that adjacent to a highly stimulated mood may be colored bright red.

According to one embodiment, selection of a mood theme by a user may be rendered still more intuitive by inclusion, in the mood selection virtual tool provided by interactive mood guided playlist assembly application 222b, of a visual cue showing simulated human facial expressions corresponding to the selected mood theme. For example, an avatar or plurality of mood expressive emoticons capable of projecting the range of moods available for selection may be utilized to reflect differences in mood corresponding to movement of the mood selection button along the mood range.

Continuing with step 340, step 340 comprises designating mood associated media assets corresponding to the mood theme identified in step 330, from the labeled media assets stored in user selected media assets database 238. Designation of mood associated media assets may be performed by interactive mood guided playlist assembly application 222b based on predetermined assignment criteria for matching the mood rating of a media asset identified in step 310 to an identified mood theme, for example.

Flowchart 300 continues with step 350, which comprises determining a media playlist length corresponding to the mood theme. In some situations, a media playlist length may be limited by a scarcity of mood associated media assets suitable for a particular identified mood theme stored in user selected media assets database 238. In other instances, user selected media assets database 238 may contain many mood associated media assets suitable to the identified mood theme. In the latter case, a media playlist length may be determined by a predetermined or user defined upper bound, imposed by interactive mood guided playlist assembly application 222b, limiting the playlist to a specific number of media assets, for example not more than twenty-five.

Moving on to step 360 of flowchart 300, step 360 comprises assembling a media playlist having the media playlist length determined in step 350, from the mood associated media assets designated in step 340. In one embodiment, assembly, in step 360, is an automated process, in which interactive mood guided playlist assembly application 222b executes assembly operations based on identification of a mood theme, playlist length, and metatag labeling of media assets stored in user selected media assets database 238. In other embodiments, the assembly process may be performed interactively with the user, enabling the user to customize the media playlist.

Thus, steps 310 through 360 of flowchart 300 describe an exemplary method for producing a mood guided media playlist. In one embodiment, a mood guided media playlist may be produced dynamically, during playback of a previously produced mood guided media playlist. For example, at some intermediate point in playback of media assets assembled during production of a relaxed playlist, the user may decide that their mood has changed to one of stimulated excitement. The user may then utilize the interactive mood guided playlist assembly program to produce an updated playlist. In one embodiment, the previous playlist may be terminated, either during playback of an individual media asset, or at conclusion of its playback, for transition to the updated playlist. In one embodiment, interactive mood guided playlist assembly application 222b may be configured to blend the updated playlist with the active playlist to provide a seamless transition between their respective content.

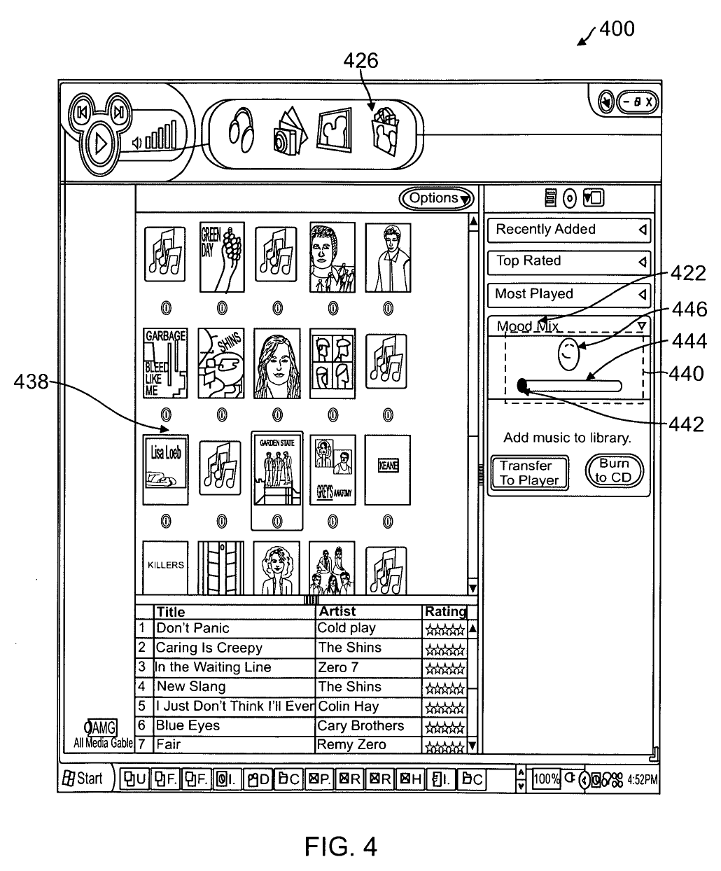

Turning now to FIG. 4, described in conjunction with FIG. 2, FIG. 4 shows visual frame 400 of a display enabling a user to produce a mood guided media playlist through use of interactive mood guided playlist assembly application 222b, in FIG. 2, according to one embodiment of the present invention. As shown in FIG. 4, music media assets stored in user selected media assets database 238 are displayed in panel 438. In the present embodiment, additional music media assets may be purchased from media assets database 224, as indicated by shopping bag icon 426, and downloaded to user selected media assets database 238, accessible from panel 438.

A user of interactive mood guided playlist assembly application 222b, in FIG. 2, can produce a music playlist using the mood guided visually intuitive functionality provided by mood mix option 422 and mood selection virtual tool 440. When mood mix option 422 is selected, visual cues in the form of mood selection button 442, mood range 444, and mood expressive emoticon 446 enable the user to intuitively recognize the type of playlist being produced. In the example of visual frame 400, mood selection button 442 is in the extreme left, i.e. very relaxed, region of mood range 444. This is further shown by the expression of mood expressive emoticon 446, as well as agreement between the color of mood range 444 in the vicinity of mood selection button 442, i.e. deep blue, and the coloring of mood expressive emoticon 446.

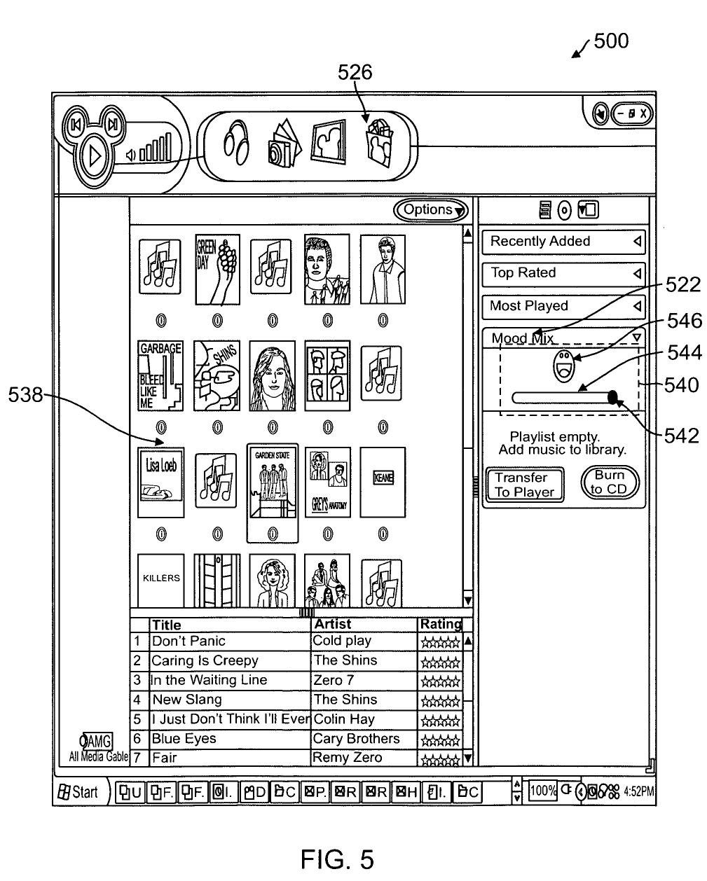

FIG. 5 shows visual frame 500 of a display enabling a user to produce a mood guided media playlist having a different mood theme than that shown in FIG. 4, according to one embodiment of the present invention. Visual frame 500 comprises user selected media assets panel 538, shopping bag icon 526, and mood mix option 522, corresponding respectively to user selected media assets panel 438, shopping bag icon 426, and mood mix option 422, in FIG. 4. Also shown in FIG. 5 is mood selection virtual tool 540 including mood selection button 542, mood range 544, and mood expressive emoticon 546, corresponding respectively to mood selection virtual tool 440 including mood selection button 442, mood range 444, and mood expressive emoticon 446, in FIG. 4.

Contrasting FIG. 5 with FIG. 4, it may be seen that in the example of visual frame 500, mood selection button 542 is in the extreme right, i.e. highly stimulated, region of mood range 544. As in FIG. 4, in FIG. 5 this is further shown by the expression of mood expressive emoticon 546 reinforcing expression of a highly stimulated mood state, as well as agreement between the color of mood range 544 in the vicinity of mood selection button 542, i.e. bright red, and the coloring of mood expressive emoticon 546.

Thus, the present application discloses methods and systems for producing a mood guided media playlist. By labeling stored media assets with metatags identifying a mood rating of each media asset, the present disclosure describes an approach to organizing media content by mood. By providing an approach that automates assembly of a media playlist based on a user selection of a particular mood state, the present disclosure further describes an approach that allows a user to almost effortlessly produce a media playlist guided by their present mood. Moreover, by providing visual cues assisting a user to recognize a desired mood state instinctively, the present application discloses a solution enabling a user to intuitively produce and modify a mood guided media playlist suited to his or her personal preferences.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. It should also be understood that the invention is not limited to the particular embodiments described herein, but is capable of many rearrangements, modifications, and substitutions without departing from the scope of the invention.

What is claimed is:

1. A method of providing a mood guided media playlist, the method comprising:
identifying a mood rating of media assets stored in a media assets database;
labeling the media assets with metatags corresponding to the mood rating;
identifying a mood theme according to an input received from a client computer;
designating mood associated media assets corresponding to the mood theme from the labeled media assets;
determining a media playlist length corresponding to the mood theme;
assembling a media playlist having the media playlist length corresponding to the mood theme, from the mood associated media assets; and
providing the media playlist for displaying.

2. The method of claim 1, further comprising providing a mood selection virtual tool enabling a user of the client computer to recognize and select a desired mood theme.

3. The method of claim 2, wherein the mood selection virtual tool is configured to display a spectrum of colors corresponding to a plurality of user selectable mood themes.

4. The method of claim 2, wherein the mood selection virtual tool is configured to display a plurality of simulated human facial expressions corresponding to a plurality of user selectable mood themes.

5. The method of claim 1, wherein the media assets comprise entertainment content including one of more of music content, music video content, video content, television content, and movie content.

6. The method of claim 1, wherein the method is performed by an interactive mood guided playlist assembly application on the client computer.

7. The method of claim 1, wherein the method is performed by an interactive mood guided playlist assembly application running on a media server as a web application.

8. A computer-readable medium having stored thereon instructions comprising an interactive mood guided playlist assembly application which, when executed by a client computer, perform a method comprising:
identifying a mood rating of media assets stored in a media assets database;
labeling the media assets with metatags corresponding to the mood rating;
identifying a mood theme according to an input received from a client computer;
designating mood associated media assets corresponding to the mood theme from the labeled media assets;
determining a media playlist length corresponding to the mood theme;
assembling a media playlist having the media playlist length corresponding to the mood theme, from the mood associated media assets; and
providing the media playlist for displaying.

9. The computer-readable medium of claim 8, wherein the method performed according to the interactive mood guided playlist assembly application further comprises providing a mood selection virtual tool enabling a user of the client computer to recognize and select a desired mood theme.

10. The computer-readable medium of claim 9, wherein the mood selection virtual tool is configured to display a spectrum of colors corresponding to a plurality of user selectable mood themes.

11. The computer-readable medium of claim 9, wherein the mood selection virtual tool is configured to display a plurality of simulated human facial expressions corresponding to a plurality of user selectable mood themes.

12. The computer-readable medium of claim 8, wherein the client computer executing the interactive mood guided playlist assembly application comprises a mobile communication device including one of a mobile telephone, a digital media player, personal digital assistant (PDA), a wireless computer, and a wireless gaming console.

13. The computer-readable medium of claim 8, wherein the media assets comprise entertainment content including one of more of music content, music video content, video content, television content, and movie content.

14. A system for providing a mood guided media playlist, the system comprising:
a media content server;
a media assets database accessible through the media content server, the media assets database configured to store a plurality of media content;
a user selected media assets database comprising media content corresponding to the plurality of media content stored on the media assets database; and
an interactive mood guided playlist assembly application accessible via the media content server, the interactive mood guided playlist assembly application configured to produce a mood guided media playlist from the media content stored in the user selected media assets database.

15. The system of claim 14, further comprising a mood selection virtual tool provided by the interactive mood guided playlist assembly application, the mood selection virtual tool configured to enable a user of the interactive mood guided playlist assembly application to recognize and select a desired mood theme.

16. The system of claim 15, wherein the mood selection virtual tool is configured to display a spectrum of colors corresponding to a plurality of user selectable mood themes.

17. The system of claim 15, wherein the mood selection virtual tool is configured to display a plurality of simulated human facial expressions corresponding to a plurality of user selectable mood themes.

18. The system of claim 14, further comprising a client computer.

19. The system of claim 14, wherein the media assets comprise entertainment content including one of more of music content, music video content, video content, television content, and movie content.

20. The system of claim 18, wherein the client computer comprises a mobile communication device including one of a mobile telephone, a digital media player, personal digital assistant (PDA), a wireless computer, and a wireless gaming console.
